(19) United States
(12) Patent Application Publication
(10) Pub. No.: US 2025/0142369 A1
(43) Pub. Date: May 1, 2025

(54) COMMUNICATION METHOD AND APPARATUS

(71) Applicant: Huawei Technologies Co., Ltd., Shenzhen (CN)

(72) Inventors: Hao Tang, Shanghai (CN); Lei Dong, Shanghai (CN); Liqing Zhang, Ottawa (CA)

(21) Appl. No.: 19/007,097

(22) Filed: Dec. 31, 2024

Related U.S. Application Data
(63) Continuation of application No. PCT/CN2022/103641, filed on Jul. 4, 2022.

(51) Int. Cl. H04W 24/02; H04B 17/391; H04W 28/02

(52) U.S. Cl. CPC H04W 24/02; H04B 17/3913; H04W 28/0268

(57) ABSTRACT

This application provides a communication method and apparatus. The method includes: A terminal device obtains first configuration information, where the first configuration information includes one or more of the following: a type of first information, a quantization granularity of the first information, a feedback resource of the first information, a feedback periodicity of the first information, a measurement resource corresponding to the first information, a reference signal corresponding to the first information, and a mapping relationship between the reference signal corresponding to the first information and the measurement resource corresponding to the first information. The terminal device sends the first information to a network device based on the first configuration information, where the first information is used to assist an artificial intelligence (AI) model of the network device. The network device assists the AI model of the network device based on the first information.

### CROSS-REFERENCE TO RELATED APPLICATIONS

This application is a continuation of International Application No. PCT/CN2022/103641, filed on Jul. 4, 2022, the disclosure of which is hereby incorporated by reference in its entirety.

### TECHNICAL FIELD

This application relates to the communication field, and specifically, to a communication method and apparatus.

### BACKGROUND

Currently, a terminal device may report channel state information (CSI) to a network device. However, CSI-related configuration information (for example, the configuration information includes a feedback periodicity and a feedback resource) is fixed. With development of technologies such as artificial intelligence (AI) and sensing, integration of a communication network, a sensing network, and a computing power network becomes one of trends of a next-generation communication system. A plurality of types of AI or sensing-related information are generated when technologies such as AI and sensing are introduced into a communication system, and the terminal may report a plurality of types of information to the network device. The information may be closely related to an environment and has a time-varying characteristic.

Therefore, the current fixed configuration and reporting mechanism can no longer meet requirements.

### SUMMARY

This application provides a communication method and apparatus, to resolve a problem that a terminal device feeds back information to a network device based on fixed configuration information.

According to a first aspect, a communication method is provided, and includes: A terminal device obtains first configuration information, where the first configuration information includes one or more of the following: a type of first information, a quantization granularity of the first information, a feedback resource of the first information, a feedback periodicity of the first information, a measurement resource corresponding to the first information, a reference signal corresponding to the first information, and a mapping relationship between the reference signal corresponding to the first information and the measurement resource corresponding to the first information. The terminal device sends the first information to a network device based on the first configuration information, where the first information is used to assist an artificial intelligence AI model of the network device.

According to the method in this application, the terminal device may flexibly send the first information to the network device based on the first configuration information. Compared with a method in which a terminal device sends first information based on a same type of configuration information, the method in this application can improve resource utilization and system spectrum utilization.

With reference to the first aspect, in some implementations of the first aspect, the quantization granularity of the first information is related to a quality of service requirement of the first information, the feedback periodicity of the first information is related to a change frequency of the first information, the feedback resource of the first information is related to an adjustment amplitude of the AI model of the network device, or the measurement resource corresponding to the first information is related to the type of the first information.

With reference to the first aspect, in some implementations of the first aspect, that a terminal device obtains first configuration information includes: The terminal device determines the quantization granularity of the first information based on the quality of service requirement of the first information; and/or the terminal device determines the feedback periodicity of the first information based on the change frequency of the first information.

According to the method in this application, the terminal device independently determines the first configuration information, so that signaling interaction between the terminal device and the network device can be reduced, and resources can be saved.

With reference to the first aspect, in some implementations of the first aspect, the method further includes: The terminal device sends the quantization granularity of the first information and/or the feedback periodicity of the first information to the network device.

With reference to the first aspect, in some implementations of the first aspect, that a terminal device obtains first configuration information includes: The terminal device obtains the first configuration information from predefined configuration information.

According to the method in this application, the terminal device obtains the first configuration information from the predefined configuration information, so that signaling interaction between the terminal device and the network device can be reduced, and resources can be saved.

With reference to the first aspect, in some implementations of the first aspect, that a terminal device obtains first configuration information includes: The terminal device obtains the first configuration information from the network device.

With reference to the first aspect, in some implementations of the first aspect, the method further includes: The terminal device obtains a mapping relationship between an index and configuration information, where the mapping relationship between an index and configuration information includes a first mapping relationship between a first index and the first configuration information. That a terminal device obtains first configuration information includes: The terminal device obtains the first configuration information based on the mapping relationship and the first index.

Compared with a method for directly sending specific content of first configuration information to a terminal device, the method in this application in which the terminal device may obtain the first configuration information by using the first index can reduce resource consumption.

With reference to the first aspect, in some implementations of the first aspect, the mapping relationship between an index and configuration information is predefined.

With reference to the first aspect, in some implementations of the first aspect, that the terminal device obtains a mapping relationship between an index and configuration information includes: The terminal device obtains the mapping relationship between an index and configuration information from the network device.

With reference to the first aspect, in some implementations of the first aspect, the method further includes: The terminal device obtains second configuration information, where the second configuration information is used to update the first configuration information, and the first configuration information is different from the second configuration information.

According to the method in this application, when one or more of the AI model of the network device, an AI model of the terminal device, a sensing network of the terminal device, and a channel state between the terminal device and the network device are updated, the terminal device updates the first configuration information, and updated first configuration information is better adapted to the AI model of the network device, the AI model of the terminal device, the channel state between the terminal device and the network device, or the sensing network of the terminal device, thereby ensuring effectiveness of a measurement and feedback procedure of the first information.

According to a second aspect, a communication method is provided, and includes: A network device receives first information from a terminal device, where the first information is used to assist an artificial intelligence AI model of the network device, the first information corresponds to first configuration information, and the first configuration information includes one or more of the following: a type of the first information, a quantization granularity of the first information, a feedback resource of the first information, a feedback periodicity of the first information, a measurement resource corresponding to the first information, a reference signal corresponding to the first information, and a mapping relationship between the reference signal corresponding to the first information and the measurement resource corresponding to the first information. The network device assists the AI model of the network device based on the first information.

According to the method in this application, the terminal device may flexibly send the first information to the network device based on the first configuration information. Correspondingly, the network device may assist the AI model of the network device based on the first information.

With reference to the second aspect, in some implementations of the second aspect, the quantization granularity of the first information is related to a quality of service requirement of the first information, the feedback periodicity of the first information is related to a change frequency of the first information, the feedback resource of the first information is related to an adjustment amplitude of the AI model of the network device, or the measurement resource corresponding to the first information is related to the type of the first information.

With reference to the second aspect, in some implementations of the second aspect, the method further includes: The network device determines the first configuration information. The network device sends the first configuration information to the terminal device.

With reference to the second aspect, in some implementations of the second aspect, the method further includes: The network device sends a mapping relationship between an index and configuration information to the terminal device, where the mapping relationship between an index and configuration information includes a first mapping relationship between a first index and the first configuration information. The network device sends the first index to the terminal device.

Compared with a method for directly sending specific content of first configuration information to a terminal device, the method in this application in which the network device may send the first index to the terminal device to indicate the first configuration information can reduce resource consumption.

With reference to the second aspect, in some implementations of the second aspect, the method further includes: If one or more of the AI model of the network device, an AI model of the terminal device, a sensing network of the terminal device, and a channel state between the terminal device and the network device are updated, the network device sends second configuration information to the terminal device, where the second configuration information is used to update the first configuration information, and the first configuration information is different from the second configuration information.

According to a third aspect, a communication apparatus is provided. The communication apparatus may be the terminal device in the first aspect, or may be an apparatus (for example, a chip, a chip system, or a circuit) in the terminal device or an apparatus that can be used together with the terminal device.

In a possible implementation, the communication apparatus may include modules or units in one-to-one correspondence with the methods/operations/steps/actions described in the first aspect. The modules or units may be implemented by a hardware circuit, software, or a communication of a hardware circuit and software.

In a possible implementation, the communication apparatus includes a transceiver unit and a processing unit connected to the transceiver unit. The transceiver unit or the processing unit is configured to obtain first configuration information, where the first configuration information includes one or more of the following: a type of first information, a quantization granularity of the first information, a feedback resource of the first information, a feedback periodicity of the first information, a measurement resource corresponding to the first information, a reference signal corresponding to the first information, and a mapping relationship between the reference signal corresponding to the first information and the measurement resource corresponding to the first information. The transceiver unit is configured to send the first information to a network device based on the first configuration information, where the first information is used to assist an artificial intelligence AI model of the network device.

With reference to the third aspect, in some implementations of the third aspect, the quantization granularity of the first information is related to a quality of service requirement of the first information, a feedback periodicity of the first information is related to a change frequency of the first information, the feedback resource of the first information is related to an adjustment amplitude of the AI model of the network device, or the measurement resource corresponding to the first information is related to the type of the first information.

With reference to the third aspect, in some implementations of the third aspect, the processing unit is configured to determine the quantization granularity of the first information based on the quality of service requirement of the first information; and/or the processing unit is configured to determine the feedback periodicity of the first information based on the change frequency of the first information.

With reference to the third aspect, in some implementations of the third aspect, the transceiver unit is configured to send the quantization granularity of the first information and/or the feedback periodicity of the first information to the network device.

With reference to the third aspect, in some implementations of the third aspect, the transceiver unit is configured to obtain the first configuration information from predefined configuration information.

With reference to the third aspect, in some implementations of the third aspect, the transceiver unit is configured to obtain the first configuration information from the network device.

With reference to the third aspect, in some implementations of the third aspect, the transceiver unit is configured to obtain a mapping relationship between an index and configuration information, where the mapping relationship between an index and configuration information includes a first mapping relationship between a first index and the first configuration information. The transceiver unit is configured to obtain the first configuration information based on the mapping relationship and the first index.

With reference to the third aspect, in some implementations of the third aspect, the mapping relationship between an index and configuration information is predefined.

With reference to the third aspect, in some implementations of the third aspect, the transceiver unit is configured to obtain the mapping relationship between an index and configuration information from the network device.

With reference to the third aspect, in some implementations of the third aspect, the transceiver unit or the processing unit is configured to obtain second configuration information, where the second configuration information is used to update the first configuration information, and the first configuration information is different from the second configuration information.

According to a fourth aspect, a communication apparatus is provided. The communication apparatus may be the network device in the second aspect, or may be an apparatus (for example, a chip, a chip system, or a circuit) in the network device or an apparatus that can be used together with the network device.

In a possible implementation, the communication apparatus may include modules or units in one-to-one correspondence with the methods/operations/steps/actions described in the second aspect. The modules or units may be implemented by a hardware circuit, software, or a communication of a hardware circuit and software.

In a possible implementation, the communication apparatus includes a transceiver unit and a processing unit connected to the transceiver unit.

The transceiver unit is configured to receive first information from a terminal device, where the first information is used to assist an artificial intelligence AI model of the network device, the first information corresponds to first configuration information, and the first configuration information includes one or more of the following: a type of the first information, a quantization granularity of the first information, a feedback resource of the first information, a feedback periodicity of the first information, a measurement resource corresponding to the first information, a reference signal corresponding to the first information, and a mapping relationship between the reference signal corresponding to the first information and the measurement resource corresponding to the first information. The processing unit is configured to assist the AI model of the network device based on the first information.

With reference to the fourth aspect, in some implementations of the fourth aspect, the quantization granularity of the first information is related to a quality of service requirement of the first information, the feedback periodicity of the first information is related to a change frequency of the first information, the feedback resource of the first information is related to an adjustment amplitude of the AI model of the network device, or the measurement resource corresponding to the first information is related to the type of the first information.

With reference to the fourth aspect, in some implementations of the fourth aspect, the processing unit is configured to determine the first configuration information. The transceiver unit is configured to send the first configuration information to the terminal device.

With reference to the fourth aspect, in some implementations of the fourth aspect, the transceiver unit is configured to send a mapping relationship between an index and configuration information to the terminal device, where the mapping relationship between an index and configuration information includes a first mapping relationship between a first index and the first configuration information. The transceiver unit is configured to send the first index to the terminal device.

With reference to the fourth aspect, in some implementations of the fourth aspect, if one or more of the AI model of the network device, an AI model of the terminal device, a sensing network of the terminal device, and a channel state between the terminal device and the network device are updated, the transceiver unit is configured to send second configuration information to the terminal device, where the second configuration information is used to update the first configuration information, and the first configuration information is different from the second configuration information.

According to a fifth aspect, a communication apparatus is provided, and includes a communication interface and a processor. The communication interface is configured to: output and/or input a signal, and the processor is configured to execute a computer program or instructions stored in a memory, so that the communication apparatus performs the method according to any one of the possible implementations of the first aspect, or the communication apparatus performs the method according to any one of possible implementations of the second aspect.

Optionally, the memory may be included in the communication apparatus. In a manner, the memory and the processor may be disposed separately. In another manner, the memory may be located in the processor and integrated with the processor.

Optionally, the memory may alternatively be outside the communication apparatus and coupled to the processor.

According to a sixth aspect, a computer-readable storage medium is provided, and includes a computer program. When the computer program is run on a computer, the computer is enabled to perform the method according to any one of the possible implementations of the first aspect and the second aspect.

According to a seventh aspect, a chip or a chip system is provided. The chip or the chip system includes a processing circuit and an input/output interface, and the processing circuit is configured to perform the method according to any one of the possible implementations of the first aspect; or the processing circuit is configured to perform the method according to any one of the possible implementations of the second aspect. The input/output interface is configured to: input and/or output a signal.

According to an eighth aspect, a computer program product is provided. The computer program product includes a computer program (which may also be referred to as code or instructions). When the computer program is run, a computer is enabled to perform the method according to any one of the possible implementations of the first aspect, or a computer is enabled to perform the method according to any one of the possible implementations of the second aspect.

According to a ninth aspect, a communication system is provided, and includes a terminal device and a network device. The terminal device is configured to perform the method according to any one of the possible implementations of the first aspect. The network device is configured to perform the method according to any one of the possible implementations of the second aspect.

### BRIEF DESCRIPTION OF THE DRAWINGS

FIG. 1 shows a communication system to which this application is applicable;

FIG. 2 shows an example of a schematic interaction diagram of a method according to this application;

FIG. 3 shows an example of a schematic interaction diagram of a method according to this application;

FIG. 4 shows an example of a schematic interaction diagram of a method according to this application;

FIG. 5 shows an example of a schematic interaction diagram of a method according to this application;

FIG. 6 shows an example of a schematic interaction diagram of a method according to this application;

FIG. 7 is a schematic block diagram of a communication apparatus according to this application; and

FIG. 8 is a schematic block diagram of a communication apparatus according to this application.

### DESCRIPTION OF EMBODIMENTS OF ILLUSTRATIVE EMBODIMENTS

Technical solutions in embodiments of this application may be applied to various 3rd generation partnership project (3GPP) communication systems, for example, a long term evolution (LTE) system, an LTE frequency division duplex (FDD) system, an LTE time division duplex (TDD) system, a 5th generation (5G) communication system, also referred to as a new radio (NR) communication system, and a future evolved communication system such as a 6th generation (6G) communication system.

It should be understood that the term “and/or” in this specification describes only an association relationship between associated objects and represents that three relationships may exist. For example, A and/or B may represent the following three cases: Only A exists, both A and B exist, and only B exists. In addition, the character “/” in this application may represent “and/or”. For example, A/B represents A and/or B.

It should be understood that in embodiments of this application, “B corresponding to A” indicates that B is associated with A, and B may be determined based on A. However, it should be further understood that determining B based on A does not mean that B is determined based only on A. B may alternatively be determined based on A and/or other information.

“A plurality of” in embodiments of this application refers to “two or more”.

Descriptions such as “first” and “second” in embodiments of this application are merely used for illustration and distinguishing between described objects, are not sequenced, do not represent a special limitation on a quantity of described objects in embodiments of this application, and do not constitute any limitation on embodiments of this application.

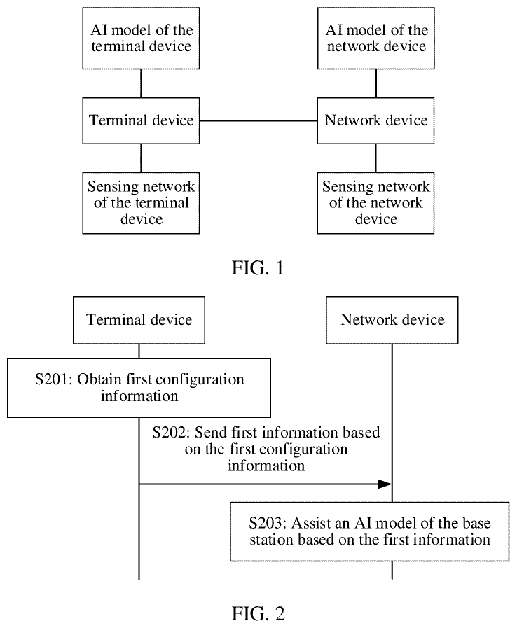

FIG. 1 shows a communication system to which this application is applicable. The system includes a terminal device, an AI model of the terminal device, a sensing network of the terminal device, a network device, an AI model of the network device, and a sensing network of the network device.

In this application, the terminal device may be various devices that provide voice and/or data connectivity for a user, or may be referred to as a terminal, user equipment (UE), a mobile station, a mobile terminal, or the like. The terminal device may be widely applied to various scenarios, for example, customer-premises equipment (CPE), a smart point of sale (POS) machine, device-to-device (D2D), vehicle-to-everything (V2X) communication, machine-type communication (MTC), internet of things (IOT), virtual reality, augmented reality, industrial control, autonomous driving, telemedicine, smart grid, smart furniture, smart office, smart wearable, smart transportation, and a smart city. The terminal may be a mobile phone, a tablet computer, a computer having a wireless transceiver function, a wearable device, an uncrewed aerial vehicle, a vehicle-mounted device, an aerospace device, or the like. In embodiments of this application, a chip used in the foregoing device may also be referred to as the terminal.

The network device in embodiments of this application may be an access network device such as a base station. The base station may be an evolved NodeB (eNB or eNodeB) in an LTE system, a next generation NodeB (gNB) in a 5th generation (5G) mobile communication system, a next generation base station in a communication system evolved after 5G, such as a 6th generation (6G) mobile communication system, or the like. A specific technology and a specific device form used by the network device are not limited in embodiments of this application. For example, the network device may be a macro base station, a micro base station (also referred to as a small cell), a relay station, an access point, a transmission point (TRP), a transmission point (TP), a mobile switching center, a network device (that is, may be deployed on a high-altitude platform or a satellite) in a non-terrestrial network (NTN) communication system, and a device that undertakes a base station function in D2D, V2X, or MTC communication. The network device may be a module or unit that completes some functions of the base station, for example, may be a central unit (CU), or may be a distributed unit (DU). The CU and the DU separately complete some protocol stack functions of the base station. In addition, functions of the CU may be implemented by a plurality of entities. For example, functions of a control plane (CP) and a user plane (UP) of the CU are separated, to form a control plane of the CU (CU-CP) and a user plane of the CU (CU-UP). For example, the CU-CP and the CU-UP may be implemented by different functional entities, and are connected through an E1 interface. The CU-CP and the CU-UP may be coupled to the DU.

For ease of understanding, the following explains some terms in this application.

### (1) Channel-Related Information:

The channel-related information includes but is not limited to one or more of the following:
a rank indicator (RI), a precoding matrix indicator (PMI), channel quality information (CQI), a CSI-reference signal resource indicator (CRI), a synchronization signal (SS)/physical broadcast channel (PBCH) resource block indicator (SSRBI), a layer indicator (LI), a layer 1-signal received power (L1-RSRP), a signal-to-noise ratio (SNR), a signal to interference plus noise ratio (SINR), and complete channel information, such as an amplitude of a channel and a phase of the channel, where the phase of the channel includes an angle of arrival (AoA) and an angle of departure (AoD).

For example, the channel-related information may be CSI.

### (2) Related Information of an AI Model of the Terminal Device:

The related information of the AI model of the terminal device includes but is not limited to one or more of the following:
accuracy of the AI model, a loss value of the AI model, a mean square error, a mean absolute error, a mean bias error, a cross entropy loss, a gradient, and a correlation between an AI model of the base station and the AI model of the terminal device.

### (3) Related Information of a Sensing Network:

The related information of the sensing network includes but is not limited to one or more of the following:
a quantity of a plurality of paths, a distance of each path, a Doppler shift, a Doppler spread, a fading rate, a level cross rate (LCR), average fading duration (AFD), a delay of multipath, an average delay, a delay spread, and sensed environment information (such as weather information such as temperature and humidity).

### (4) Related Information of System Performance:

The related information of the system performance includes but is not limited to one or more of the following:
a block error rate (BLER), a bit error rate (BER), code block group error ratio, a throughput, and a latency.

The related information of the system performance may be obtained by using an AI model, or may be independently obtained (not by using an AI model).

### (5) AI Assistance Information:

The AI assistance information is used to assist an AI model of the network device, for example, assist the AI model in performing operations such as training, inference, verification, and testing. The AI assistance information may be used as an input parameter for training, inferring, verifying, or testing the AI model. For example, the AI assistance information may be training data of the AI model of the network device.

The AI assistance information includes but is not limited to one or more of the following:
CSI, related information of an AI model of the terminal device, related information of a sensing network of the terminal device, and related information of system performance.

In other words, the AI assistance information may further include another type of information. For example, the training data of the AI model of the network device may further include another type of information.

The following describes solutions of this application.

FIG. 2 shows a method 200 according to this application. The method 200 includes the following steps.
S201: A terminal device obtains first configuration information, where the first configuration information is associated with a type of first information.

Specifically, a manner in which the terminal device obtains the first configuration information includes: The terminal device independently determines the first configuration information, the terminal device obtains the first configuration information from predefined configuration information according to a protocol, or the terminal device obtains the first configuration information from a network device. For a detailed process, refer to the following method 300 to method 600.

The first configuration information includes one or more of the following:
the type of the first information, a quantization granularity of the first information, a feedback resource of the first information, a feedback periodicity of the first information, a measurement resource corresponding to the first information, a reference signal corresponding to the first information, a mapping relationship between the reference signal corresponding to the first information and the measurement resource corresponding to the first information.

It should be understood that the first information in this application may be understood as a type of information.

For example, the feedback resource of the first information and the measurement resource corresponding to the first information include a time domain resource, a frequency domain resource, a code domain resource, a density, a sequence, and the like.

For example, the type of the first information includes but is not limited to one or more of the following:
CSI, related information of an AI model of the terminal device, related information of a sensing network of the terminal device, and related information of system performance.

In a possible implementation, the first information needs to be obtained by measuring a reference signal. In this case, the first configuration information includes one or more of the measurement resource corresponding to the first information, the reference signal corresponding to the first information, and the mapping relationship between the reference signal corresponding to the first information and the measurement resource corresponding to the first information, where the measurement resource corresponding to the first information is a resource occupied by the reference signal corresponding to the first information.

For example, the reference signal corresponding to the first information may include but is not limited to one or more of the following: a type of the reference signal corresponding to the first information, a generation sequence of the reference signal corresponding to the first information, and a generation criterion of the reference signal corresponding to the first information.

It should be further understood that the quantization granularity may represent a quantity of bits indicating information. For example, a larger quantization granularity of the first information indicates that the terminal device may transmit the first information by using fewer bits.

In a possible implementation, the quantization granularity of the first information is related to a quality of service requirement (for example, a reliability requirement) of the first information, the feedback periodicity of the first information is related to a change frequency of the first information, the feedback resource of the first information is related to an adjustment amplitude of the AI model of the network device, and the measurement resource corresponding to the first information is related to the type of the first information. This is described in detail below.

The feedback periodicity (or referred to as a reporting periodicity) of the first information may be a periodicity in which the terminal device feeds back/reports the first information to the network device.
S202: The terminal device sends the first information to the network device based on the first configuration information, and correspondingly, the network device receives the first information from the terminal device.

The first information is used to assist the AI model of the network device. That is, the first information is AI assistance information. It can be learned from the foregoing descriptions that the type of the first information includes but is not limited to one or more of the following:
the CSI, the related information of the AI model of the terminal device, the related information of the sensing network of the terminal device, and the related information of the system performance.

The following describes the process in different cases.

### Case 1:

A manner of obtaining the first information is: obtaining the first information by measuring a reference signal (for example, the type of the first information is the CSI or the related information of the sensing network).

The network device may send the reference signal to the terminal device on the measurement resource corresponding to the first information. Correspondingly, the terminal device may receive the reference signal from the network device based on the reference signal (for example, a sequence corresponding to the reference signal) corresponding to the first information and the measurement resource corresponding to the first information, measure the reference signal to obtain the first information, and further send the first information to the network device based on the feedback resource and the feedback periodicity of the first information.

In a possible implementation, in a process of obtaining the first information through measurement, the terminal device may generate the first information based on the quantization granularity of the first information.

For example, if the terminal device determines, based on the quantization granularity of the first information, to use 3 bits to carry the first information, in a process of generating the first information, the terminal device uses the 3 bits to indicate the first information.

### Case 2:

The first information does not need to be obtained by measuring a reference signal. In this case, the network device does not need to send the reference signal, and the terminal device does not need to measure the reference signal. The terminal device may directly obtain the first information, and send the first information to the network device based on the feedback resource and the feedback periodicity of the first information.

In addition, in a process in which the terminal device directly obtains the first information, the terminal device may generate the first information based on the quantization granularity of the first information.
S203: The network device assists the AI model of the network device based on the first information.

In this process, the network device may use the first information as input to assist the AI model in performing operations such as training, inference, verification, and testing.

The following describes the process by using several examples.

### Example 1

The first information includes first CSI. The network device may use the first CSI as input to train the AI model of the network device. The AI model of the network device may be used to predict second CSI. The first CSI and the second CSI are CSI at different moments or different ports.

In a possible case, the prediction process may include the following steps:
Step 1: The network device sends a CSI-RS to the terminal device at a first moment through a downlink channel.
Step 2: The terminal device measures the CSI-RS, to obtain first CSI of the downlink channel at the first moment.
Step 3: The terminal device sends the first CSI of the downlink channel at the first moment to the network device.
Step 4: The network device predicts, by using the AI model, second CSI of the downlink channel at a second moment based on the first CSI of the downlink channel at the first moment.

For example, the network device may perform prediction based on a deep neural network model, perform prediction based on a Kalman prediction model, perform prediction according to a Prony method, or perform prediction based on a linear or nonlinear prediction algorithm. This is not limited in this application. A method or a model used by the network device for prediction is not described below.

In another case, the prediction process may include the following steps:
Step 1: The network device sends a CSI-RS to the terminal device at a first moment through a first port.
Step 2: The terminal device measures the CSI-RS, to obtain first CSI of the first port at the first moment.
Step 3: The terminal device sends the first CSI of the first port at the first moment to the network device.
Step 4: The network device predicts, by using the AI model, second CSI of a second port at the first moment based on the CSI of the first port at the first moment.

### Example 2

The first information includes a BLER at a first moment. The network device may use the BLER at the first moment as input to train the AI model of the network device. The AI model may be used to predict a BLER at a second moment.

### Example 3

The first information includes location information of the terminal device at a first moment. The network device may use the location information of the terminal device at the first moment as an input to train the AI model of the network device. The AI model may be used to predict location information of the terminal device at a second moment.

According to the method in this application, the terminal device may send the first information to the network device based on the first configuration information. The first configuration information includes the type of the first information, and may further include other configuration information in addition to the type, for example, the quantization granularity of the first information, the feedback resource of the first information, the feedback periodicity of the first information, the measurement resource corresponding to the first information, the reference signal corresponding to the first information, and the mapping relationship between the reference signal corresponding to the first information and the measurement resource corresponding to the first information.

Therefore, the terminal device may flexibly send the first information based on the first configuration information. For example, different types of first information may be sent, and configuration information of each type of first information may be different. For example, feedback resources of the different types of first information may be different. In addition, configuration information of a same type of first information may be different. For example, related information of the AI model of the terminal device may be fed back at different periodicities or resources. Compared with a method in which a terminal device sends first information based on a same type of configuration information, the method in this application can improve resource utilization and system spectrum utilization.

Optionally, if one or more of the AI model of the network device, the AI model of the terminal device, the sensing network of the terminal device, and a channel state between the terminal device and the network device are updated, the method further includes:
S204: The terminal device obtains second configuration information.

Specifically, a manner in which the terminal device obtains the second configuration information includes: The terminal device independently determines the second configuration information, or the terminal device obtains the second configuration information from the network device. For a detailed process, refer to the following method 300 to method 600.

The second configuration information is used to update the first configuration information, and the first configuration information is different from the second configuration information.

Specifically, the second configuration information is used to update one or more of the following in the first configuration information:
the type of the first information, the quantization granularity of the first information, the feedback resource of the first information, the feedback periodicity of the first information, the measurement resource corresponding to the first information, the reference signal corresponding to the first information, the mapping relationship between the reference signal corresponding to the first information and the measurement resource corresponding to the first information.

For example, before S204, the quantization granularity of the first information is M1 bits, and the quantization granularity of the first information is updated to M2 bits in S204.

For another example, before S204, the feedback periodicity of the first information is single feedback, and the feedback periodicity of the first information is updated to feedback N times at a periodicity of T in S204.

For another example, before S204, the terminal device needs to feed back CSI to the network device; and the terminal device no longer feeds back the CSI to the network device based on the second configuration information in S204.

According to the method in this application, when one or more of the AI model of the network device, the AI model of the terminal device, the sensing network of the terminal device, and the channel state between the terminal device and the network device are updated, the first configuration information corresponding to the first information is also correspondingly updated, and updated first configuration information is better adapted to the AI model of the network device, the AI model of the terminal device, the channel state between the terminal device and the network device, or the sensing network of the terminal device, thereby ensuring effectiveness of a measurement and feedback procedure of the first information.

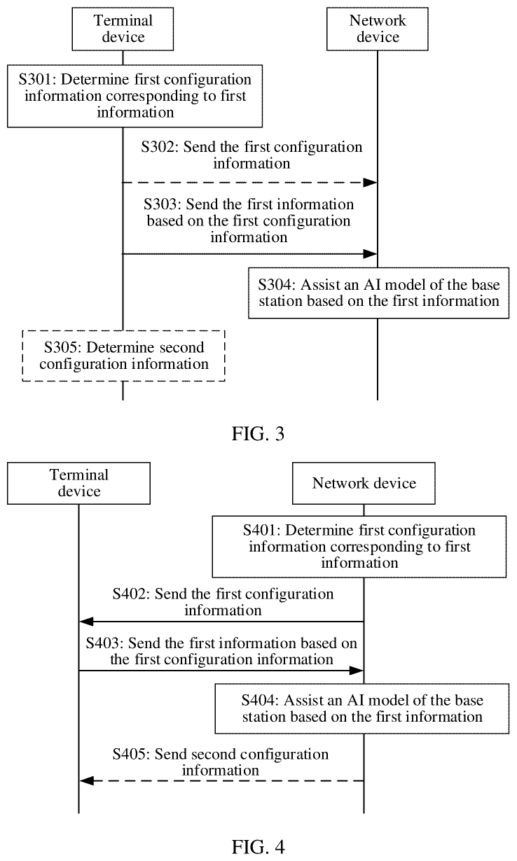

The following further describes the method 200 with reference to FIG. 3 to FIG. 6.

FIG. 3 shows a method 300. In the method 300, a manner in which a terminal device obtains first configuration information corresponding to first information is as follows: The terminal device independently determines the first configuration information. Specifically, the method 300 includes the following steps.
S301: The terminal device determines the first configuration information corresponding to the first information. For descriptions of the first configuration information, refer to S201.

Specifically, the terminal device may determine some parameters in the first configuration information based on a type of the first information. In other words, some parameters in the first configuration information are related to the type of the first information.

In a possible implementation, the terminal device may determine a quantization granularity of the first information based on a quality of service requirement of the first information.

For example, if the quality of service requirement of the first information is less than a first threshold, the terminal device determines that the first information corresponds to a first quantization granularity; or if the quality of service requirement of the first information is greater than or equal to a first threshold, the terminal device determines that the first information corresponds to a second quantization granularity, where the second quantization granularity is less than the first quantization granularity.

Therefore, according to the method in this application, if the quality of service requirement of the first information is low, the first information may be transmitted based on a large quantization granularity (a small quantity of bits), thereby saving resources.

In a possible implementation, the terminal device may determine a feedback periodicity of the first information based on a change frequency of the first information.

For example, if the change frequency of the first information is greater than a second threshold (in other words, the first information has a time-varying characteristic), the terminal device determines that the first information corresponds to a first feedback periodicity; or if the change frequency of the first information is less than or equal to a second threshold (in other words, the first information has a slowly-varying characteristic), the terminal device determines that the first information corresponds to a second feedback periodicity, where the second feedback periodicity is greater than the first feedback periodicity.

For example, for a block error rate, a bit error rate, a code block group error rate, a location of the terminal device, a speed of the terminal device, and surrounding environment information, the terminal device may perform feedback based on a long feedback periodicity, or the terminal device may perform feedback to a network device only once (that is, a feedback periodicity is infinitely long). For channel-related information (for example, CSI), the terminal device may perform feedback based on a short feedback periodicity.

Therefore, according to the method in this application, if the first information has the time-varying characteristic, the feedback periodicity of the first information is short, to avoid a case in which feedback is not performed in a timely manner; or if the first information has the slowly-varying characteristic, the feedback periodicity of the first information is long, to save resources.

In a possible implementation, the terminal device may determine the feedback resource of the first information from a plurality of feedback resources configured by the network device.

For example, the network device pre-configures a first feedback resource and a second feedback resource for the terminal device. The terminal device may determine the feedback resource of the first information from the two feedback resources.

For example, the terminal device may determine the feedback resource of the first information from the two feedback resources based on a data amount of the first information. The data amount of the first information is an amount of data included in the first information, for example, a quantity of bits or bytes included in the first information.

Specifically, if the data amount of the first information is greater than a third threshold, the terminal device selects, from the two feedback resources, a feedback resource including a large quantity of slots, symbols, resource elements (RE), or resource blocks (RB); or if the data amount of the first information is less than or equal to a third threshold, the terminal device selects, from the two feedback resources, a feedback resource including a small quantity of slots, symbols, REs, or RBs.

For another example, the network device may send information about an adjustment amplitude of an AI model of the network device to the terminal device, and the terminal device may determine the feedback resource of the first information from the two feedback resources based on the information about the adjustment amplitude of the AI model of the network device.

Specifically, if the adjustment amplitude of the AI model of the network device is greater than a fourth threshold, the terminal device selects, from the two feedback resources, a feedback resource including a large quantity of slots, symbols, REs, or RBs; or if the adjustment amplitude of the AI model of the network device is less than or equal to a fourth threshold, the terminal device selects, from the two feedback resources, a feedback resource including a small quantity of slots, symbols, REs, or RBs.

Therefore, according to the method in this application, the terminal device can flexibly determine the feedback resource of the first information, to avoid a waste of resources.

In a possible implementation, the terminal device may determine, from a plurality of measurement resources configured by the network device, a measurement resource corresponding to the first information.

For example, the network device pre-configures a measurement resource #1 and a measurement resource #2 for the terminal device. The terminal device may determine, from the two measurement resources, the measurement resource corresponding to the first information.

For example, the terminal device may determine, based on the type of the first information, the measurement resource corresponding to the first information. When the type of the first information is related information of a sensing network, for example, a quantity of a plurality of paths, a length of each path, a Doppler shift, or a Doppler spread, a large quantity of measurement resources are needed for obtaining the first information, and the terminal device may select, from the two measurement resources, a measurement resource including a large quantity of slots, symbols, REs, or RBs.

Therefore, according to the method in this application, the terminal device can flexibly determine the measurement resource corresponding to the first information, to avoid a waste of resources.

Optionally, in a manner, the terminal device may alternatively independently determine a reference signal corresponding to the first information and a mapping relationship between the reference signal corresponding to the first information and the measurement resource corresponding to the first information.

In an implementation, the terminal device may generate a pseudo-random sequence based on a base sequence, where the pseudo-random sequence includes some parameters, and these parameters are related to a configuration (for example, a quantity of symbols, a configuration of a frame structure, or a scrambling identifier (ID) of the terminal device) of the terminal device. Further, the terminal device determines, from the pseudo-random sequence, a generation sequence of the reference signal corresponding to the first information. Further, the terminal device determines, based on a pre-configured rule or algorithm, measurement resources (for example, a time domain resource, a frequency domain resource, and a code domain resource) corresponding to different symbols in the generation sequence.

Optionally, in another manner, the network device may configure, for the terminal device, a reference signal corresponding to the first information and a mapping relationship between the reference signal corresponding to the first information and the measurement resource corresponding to the first information. In other words, the terminal device may not be able to independently determine the information.

In addition, the foregoing possible implementations are not separated, and may be combined with each other.
S302: The terminal device sends the first configuration information to the network device, and correspondingly, the network device receives the first configuration information from the terminal device.

That is, the terminal device sends, to the network device, the first configuration information independently determined in S301.

For example, the terminal device reports, to the network device, the independently determined quantization granularity corresponding to the first information and/or the independently determined feedback periodicity of the first information.

For another example, the terminal device reports, to the network device, the independently determined measurement resource corresponding to the first information and/or the independently determined reference signal corresponding to the first information, and the network device may send, on a measurement resource determined by the terminal device, a reference signal determined by the terminal device.

It should be understood that if the first information does not need to be obtained by measuring the reference signal, the terminal device may not send, to the network device, the measurement resource corresponding to the first information and/or the reference signal corresponding to the first information. That is, S302 is optional.

S303: The terminal device sends the first information to the network device based on the first configuration information, and correspondingly, the network device receives the first information from the terminal device.

For this process, refer to S202.
S304: The network device assists the AI model of the network device based on the first information.

For this process, refer to S203.

According to the method in this application, the terminal device may determine different first configuration information based on different types of first information, and then send the first information to the network device based on the first configuration information. Compared with a method in which a terminal device sends a plurality of types of first information based on a same type of configuration information, the method in this application can improve resource utilization and system spectrum utilization.

Optionally, if one or more of the AI model of the network device, an AI model of the terminal device, a sensing network of the terminal device, and a channel state between the terminal device and the network device are updated, the method further includes:
S305: The terminal device determines second configuration information, where the second configuration information is used to update the first configuration information, and the first configuration information is different from the second configuration information.

In a possible implementation, if the network device sends first indication information to the terminal device, where the first indication information indicates that the AI model of the network device is updated, the terminal device determines the second configuration information based on the first indication information.

For example, if the first indication information indicates that the adjustment amplitude of the AI model of the network device is updated from being originally less than a fourth threshold to being greater than the fourth threshold, the terminal device re-determines the feedback resource of the first information.

For another example, if the AI model that is of the network device and that exists before the update has a capability of predicting the location of the terminal device, and the first indication information indicates that an updated AI model of the network device does not have the capability of predicting the location of the terminal device, the terminal device updates the type of the first information, where an updated type of the first information no longer includes the location of the terminal device. That is, the terminal device no longer feeds back location information of the terminal device to the network device.

In a possible implementation, if the terminal device determines that the AI model of the terminal device is updated, the terminal device determines the second configuration information based on an updated AI model of the terminal device.

For example, if a gradient of the AI model that is on the terminal device side and that exists before the update changes slowly, the terminal device feeds back the gradient of the AI model of the terminal device to the network device based on a long feedback periodicity. If a gradient of the updated AI model of the terminal device changes frequently, the terminal device feeds back the gradient of the AI model of the terminal device to the network device based on a short feedback periodicity.

In a possible implementation, if the terminal device determines that the sensing network of the terminal device is updated, the terminal device determines the second configuration information based on an updated sensing network of the terminal device.

For example, if an output result of the sensing network that is of the terminal device and that exists before the update is an ambient temperature, the terminal device feeds back the ambient temperature to the network device based on a long feedback periodicity. If an output result of the updated sensing network of the terminal device is a speed of the terminal device, the terminal device feeds back the speed of the terminal device to the network device based on a short feedback periodicity.

In a possible implementation, if the terminal device determines that the channel state between the terminal device and the network device is updated, and an updated channel state does not match the first configuration information, the terminal device determines the second configuration information based on the updated channel state.

For example, if the terminal device determines, based on CSI obtained through measurement, that the channel state is updated, and the updated channel state does not match at least one of the feedback resource of the first information, the feedback periodicity of the first information, and the measurement resource corresponding to the first information that are in the first configuration information, the terminal device determines the second configuration information.

According to the method in this application, when one or more of the AI model of the network device, the AI model of the terminal device, the sensing network of the terminal device, and the channel state between the terminal device and the network device are updated, the terminal device updates the first configuration information, and updated first configuration information is better adapted to the AI model of the network device, the AI model of the terminal device, the channel state between the terminal device and the network device, or the sensing network of the terminal device, thereby ensuring effectiveness of a measurement and feedback procedure of the first information.

FIG. 4 shows a method 400. In the method 400, a manner in which a terminal device obtains first configuration information corresponding to first information is as follows: The terminal device obtains the first configuration information from a network device. Specifically, the method 400 includes the following steps.
S401: The network device determines the first configuration information corresponding to the first information.

For example, the network device may determine that a type of the first information is one or more of CSI, related information of an AI model of the terminal device, related information of a sensing network of the terminal device, and related information of system performance.

The following describes, in several possible implementations, a process in which the network device determines the first configuration information.

In a possible implementation, if a quality of service requirement of the first information is less than a first threshold, the network device determines that the first information corresponds to a first quantization granularity; or if a quality of service requirement of the first information is greater than or equal to a first threshold, the network device determines that the first information corresponds to a second quantization granularity, where the second quantization granularity is less than the first quantization granularity.

In a possible implementation, if a change frequency of the first information is greater than a second threshold (in other words, the first information has a time-varying characteristic), the network device determines that the first information corresponds to a first feedback periodicity; or if a change frequency of the first information is less than or equal to a second threshold (in other words, the first information has a slowly-varying characteristic), the network device determines that the first information corresponds to a second feedback periodicity, where the second feedback periodicity is greater than the first feedback periodicity.

In a possible implementation, the network device may determine a feedback resource of the first information based on an adjustment amplitude of an AI model of the network device.

Specifically, if the adjustment amplitude of the AI model of the network device is greater than a fourth threshold, a feedback resource allocated by the network device includes a large quantity of slots, symbols, REs, or RBs; or if the adjustment amplitude of the AI model of the network device is less than or equal to a fourth threshold, a feedback resource allocated by the network device includes a small quantity of slots, symbols, REs, or RBs.

In a possible implementation, the network device may determine, based on the type of the first information, a measurement resource corresponding to the first information.

For example, when the type of the first information is related information of a sensing network, for example, a quantity of a plurality of paths, a length of each path, a Doppler shift, or a Doppler spread, a large quantity of measurement resources are needed for obtaining the first information, and the network device may allocate a measurement resource including a large quantity of slots, symbols, REs, or RBs.

In addition, the foregoing possible implementations are not separated, and may be combined with each other.
S402: The network device sends the first configuration information to the terminal device, and correspondingly, the terminal device receives the first configuration information from the network device.

For example, the first configuration information includes one or more of the following:
the type of the first information, a quantization granularity of the first information, a feedback resource of the first information, a feedback periodicity of the first information, a measurement resource corresponding to the first information, a reference signal corresponding to the first information, a mapping relationship between the reference signal corresponding to the first information and the measurement resource corresponding to the first information.

It should be understood that the network device may send the first configuration information to the terminal device by using one or more messages. This is not limited in this application. If the network device sends the first configuration information to the terminal device by using a plurality of messages, where each of the plurality of messages may include one or more of the following configuration information: the type of the first information, the quantization granularity of the first information, the feedback resource of the first information, the feedback periodicity of the first information, the measurement resource corresponding to the first information, the reference signal corresponding to the first information, and the mapping relationship between the reference signal corresponding to the first information and the measurement resource corresponding to the first information.

The first configuration information may be carried by using higher layer signaling or physical layer signaling. The higher layer signaling may include, for example, radio resource control (RRC) signaling, medium access control (MAC) control element (CE), and radio link control (RLC) signaling. The physical layer signaling may include, for example, physical downlink control information (DCI) and signaling transmitted through a physical downlink channel. The physical downlink channel may be, for example, a physical downlink control channel (PDCCH) or a physical downlink shared channel (PDSCH).
S403: The terminal device sends the first information to the network device based on the first configuration information, and correspondingly, the network device receives the first information from the terminal device.

For this process, refer to S202.
S404: The network device assists an AI model of the network device based on the first information.

For this process, refer to S203.

According to the method in this application, the terminal device may obtain the first configuration information from the network device. For different types of first information, corresponding first configuration information may also be different. Therefore, the terminal device may flexibly send a plurality of types of first information based on a plurality of types of first configuration information. Compared with a method in which a terminal device sends a plurality of types of first information based on a same type of configuration information, the method in this application can improve resource utilization and system spectrum utilization.

Optionally, if one or more of the AI model of the network device, the AI model of the terminal device, the sensing network of the terminal device, and a channel state between the terminal device and the network device are updated, the method further includes:
S405: The network device sends second configuration information to the terminal device, and correspondingly, the terminal device receives the second configuration information, where the second configuration information is used to update the first configuration information, and the first configuration information is different from the second configuration information.

The following describes a process in which the network device determines the second configuration information.

In a possible implementation, if the network device determines that the AI model of the network device is updated, the network device determines the second configuration information based on an updated AI model of the network device.

For example, if the adjustment amplitude of the AI model of the network device is updated from being originally less than a fourth threshold to being greater than the fourth threshold, the network device updates one or more of the feedback periodicity of the first information, the feedback resource of the first information, and the measurement resource corresponding to the first information.

For another example, if the AI model that is of the network device and that exists before the update has a capability of predicting a location of the terminal device, and the updated AI model of the network device does not have the capability of predicting the location of the terminal device, the terminal device updates the type of the first information, where an updated type of the first information no longer includes the location of the terminal device. In other words, the terminal device no longer feeds back location information of the terminal device to the network device based on the second configuration information.

In a possible implementation, if the terminal device sends second indication information to the network device, where the second indication information indicates that the AI model of the terminal device is updated, the network device determines the second configuration information based on the second indication information.

For example, if a gradient of the AI model that is of the terminal device and that exists before the update changes slowly, a feedback periodicity of the gradient is long. If the second indication information indicates that a gradient of an updated AI model of the terminal device changes frequently, a feedback periodicity of the gradient is short.

In a possible implementation, if the terminal device sends third indication information to the network device, where the third indication information indicates that the sensing network of the terminal device is updated, the network device determines the second configuration information based on the third indication information.

For example, if an output result of the sensing network that is of the terminal device and that exists before the update is an ambient temperature, a feedback periodicity of the ambient temperature is long. If the third indication information indicates that an output result of the updated sensing network of the terminal device is a speed of the terminal device, a feedback periodicity of the speed of the terminal device is short.

In a possible implementation, if the network device determines that a channel state between the terminal device and the network device is updated, and an updated channel state does not match the first configuration information, the network device determines the second configuration information based on the updated channel state.

For example, if the network device determines, based on CSI fed back by the terminal device, that the channel state is updated, and the updated channel state does not match at least one of the feedback resource of the first information, the feedback periodicity of the first information, and the measurement resource corresponding to the first information that are in the first configuration information, the network device determines the second configuration information.

According to the method in this application, when one or more of the AI model of the network device, the AI model of the terminal device, the sensing network of the terminal device, and the channel state between the terminal device and the network device are updated, the network device updates the first configuration information, and updated first configuration information is better adapted to the AI model of the network device, the AI model of the terminal device, the channel state between the terminal device and the network device, or the sensing network of the terminal device, thereby ensuring effectiveness of a measurement and feedback procedure of the first information.

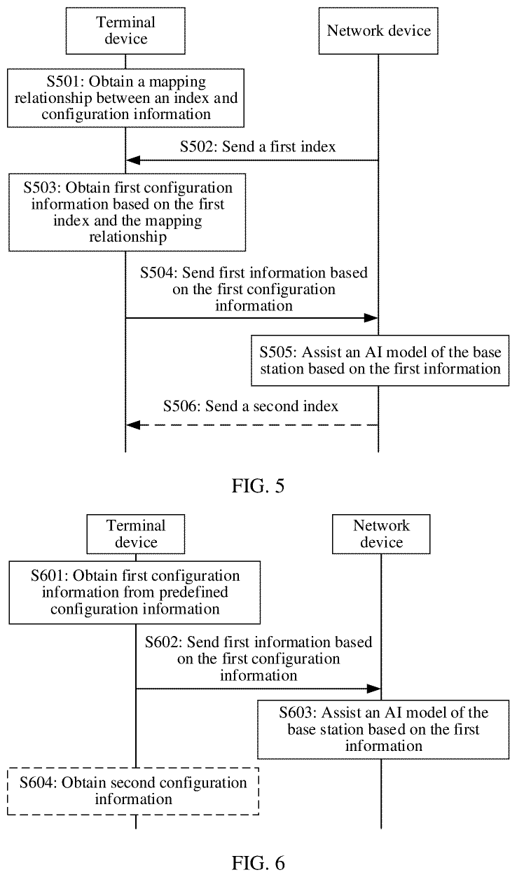

FIG. 5 shows a method 500. In the method 500, a manner in which a terminal device obtains first configuration information corresponding to first information is as follows: The terminal device obtains the first configuration information based on a first index and a mapping relationship between an index and configuration information. Specifically, the method 500 includes the following steps.
S501: The terminal device obtains the mapping relationship between an index and configuration information.

For ease of description, the mapping relationship between an index and configuration information that is obtained by the terminal device is denoted as a mapping relationship #A. The mapping relationship #A includes a first mapping relationship between the first index and the first configuration information.

In a manner, the network device may send the mapping relationship #A to the terminal device, and correspondingly, the terminal device receives the mapping relationship #A.

The mapping relationship #A may be carried by using higher layer signaling or physical layer signaling. For related descriptions of the higher layer signaling and the physical layer signaling, refer to the foregoing descriptions.

In another manner, the mapping relationship #A may alternatively be predefined in a protocol.

For example, the mapping relationship #A is shown in Table 1. In Table 1, a same type of first information may correspond to a plurality of different types of other configuration information, and the other configuration information includes one or more of a quantization granularity of the first information, a feedback resource of the first information, a feedback periodicity of the first information, a measurement resource corresponding to the first information, a reference signal corresponding to the first information, and a mapping relationship between the reference signal corresponding to the first information and the measurement resource corresponding to the first information.

In addition, if one or more of the quantization granularity of the first information, the feedback resource of the first information, the feedback periodicity of the first information, the measurement resource corresponding to the first information, the reference signal corresponding to the first information, and the mapping relationship between the reference signal corresponding to the first information and the measurement resource corresponding to the first information are not included in the mapping relationship #A, the information may be predefined.

TABLE 1

| | Measurement | Feedback | | Type of first | Quantization |
|---|---|---|---|---|---|
| Index | resource | periodicity | Feedback resource | information | granularity |
| 1 | First time domain | Single | Second time | Quantity of a | M1 bits |
| | resource, first | feedback | domain | plurality of paths | |
| | frequency domain | | resource, second | | |
| | resource, and first | | frequency | | |
| | code domain | | domain | | |
| | resource | | resource, and | | |
| | | | second code | | |
| | | | domain resource | | |
| 2 | None | Feedback | Third time | Gradient of an | M2 bits |
| | | N times | domain | AI model of a | |
| | | at a | resource, third | terminal device | |
| | | periodicity | frequency | | |
| | | of T | domain | | |
| | | | resource, and | | |
| | | | third code | | |
| | | | domain resource | | |
| . . . | . . . | . . . | . . . | . . . | . . . |

In Table 1, the type of the first information belongs to some subcategories in some categories. For example, the quantity of a plurality of paths belongs to related information of a sensing network. In another manner, as shown in Table 1-2, the type of the first information may belong to some categories. As shown in Table 1-2-1, the type of the first information belongs to some subcategories in related information of an AI model. As shown in Table 1-2-2, the type of the first information belongs to some subcategories in related information of a sensing network.

TABLE 1-2

| | Measurement | Feedback | | Type of first | Quantization |
|---|---|---|---|---|---|
| Index | resource | periodicity | Feedback resource | information | granularity |
| 1 | Time domain | Feedback N | Time domain | CSI | M1 bits |
| | resource #A, | times at a | resource #B, | | |
| | frequency domain | periodicity | frequency domain | | |
| | resource #A, and | of T | resource #B, and | | |
| | code domain | | code domain | | |
| | resource #B | | resource #B | | |
| 2 | None | Feedback N | Time domain | Related | M2 bits |
| | | times at a | resource #C, | information | |
| | | periodicity of | frequency domain | of an AI | |
| | | 2T | resource #C, and | model | |
| | | | code domain | | |
| | | | resource #C | | |
| 3 | None | Single feedback | Time domain | Related | M3 bits |
| | | | resource #D, | information | |
| | | | frequency domain | of a sensing | |
| | | | resource #D, and | network | |
| | | | code domain | | |
| | | | resource #D | | |

TABLE 1-2

| | Measurement | Feedback | | Type of first | Quantization |
|---|---|---|---|---|---|
| Index | resource | periodicity | Feedback resource | information | granularity |
| 2-1 | None | Feedback N | Time domain resource | Gradient of | M2 bits |
| | | times at a | #C1, frequency domain | an AI model | |
| | | periodicity of | resource #C1, and code | | |
| | | 2T | domain resource #C1 | | |
| 2-2 | None | Feedback N | Time domain resource | Loss value of | M2 bits |
| | | times at a | #C2, frequency domain | an AI model | |
| | | periodicity of | resource #C2, and code | | |
| | | 2T | domain resource #C2 | | |
| . . . | . . . | . . . | . . . | . . . | . . . |

TABLE 1-2

| | Measurement | Feedback | | Type of first | Quantization |
|---|---|---|---|---|---|
| Index | resource | periodicity | Feedback resource | information | granularity |
| 3-1 | None | Single | Time domain resource | Quantity of a | M3 bits |
| | | feedback | #D1, frequency domain | plurality of paths | |
| | | | resource #D1, and code | | |
| | | | domain resource #D1 | | |
| 3-2 | None | Single | Time domain resource | Doppler shift | M3 bits |
| | | feedback | #D2, frequency domain | | |
| | | | resource #D2, and code | | |
| | | | domain resource #D2 | | |
| . . . | . . . | . . . | . . . | . . . | . . . |

For another example, the mapping relationship #A includes a mapping relationship #A1 and a mapping relationship #A2. As shown in Table 2, the mapping relationship #A1 is a mapping relationship between an index and the type of the first information. As shown in Table 3, the mapping relationship #A2 is a mapping relationship between the type of the first information and other configuration information.

TABLE 2

| Index | Type of first information |
|---|---|
| 1 | Quantity of a plurality of paths |
| 2 | Doppler information (precision level 1) |
| 3 | Doppler information (precision level 2) |
| 4 | Complete channel information |
| . . . | . . . |

TABLE 3

| Type of first information | Other configuration information |
|---|---|
| Quantity of a plurality of | Measurement resource #1, feedback resource |
| paths | #1, single feedback, and quantization |
| | granularity #1 |
| Doppler information | Low-density reference signal, single feedback, |
| (precision level 1) | and quantization granularity #2 |
| Doppler information | High-density reference signal, feedback N |
| (precision level 2) | times at a periodicity of T1, and quantization |
| | granularity #3 |
| Complete channel | Measurement resource #2, feedback resource |
| information | #2, feedback M times at a periodicity of T2, |
| | and quantization granularity #4 |
| . . . | . . . |

It should be understood that Table 2 and Table 3 need to be used together.
S502: The network device sends the first index to the terminal device, and correspondingly, the terminal device receives the first index.

For example, the network device also stores the information in Table 1, or stores the information in Table 2 and Table 3.

The first index is one of a plurality of indexes in S501, and the first index is associated with the first configuration information. In an implementation, the network device may send DCI to the terminal device, where the DCI includes the first index.

For example, as shown in Table 1, the first index may indicate “i” to send configuration information corresponding to “Quantity of a plurality of paths” to the terminal device; and the first index may indicate “2” to send configuration information corresponding to “Gradient of an AI model of a terminal device” to the terminal device.

For example, as shown in Table 2, the first index may indicate “i” to send configuration information corresponding to “Quantity of a plurality of paths” to the terminal device; and the first index may indicate “4” to send configuration information corresponding to “Complete channel information” to the terminal device.
S503: The terminal device obtains the first configuration information based on the first index and the mapping relationship #A received in S501.
S504: The terminal device sends the first information to the network device based on the first configuration information, and correspondingly, the network device receives the first information from the terminal device.

For this process, refer to S202.
S505: The network device assists an AI model of the network device based on the first information.

For this process, refer to S203.

According to the method in this application, the terminal device obtains the first configuration information based on the mapping relationship #A and the first index. For different types of first information, corresponding first configuration information may also be different. Therefore, the terminal device may flexibly send a plurality of types of first information based on a plurality of types of first configuration information. Compared with a method in which a terminal device sends a plurality of types of first information based on a same type of configuration information, the method in this application can improve resource utilization and system spectrum utilization.

Optionally, if one or more of the AI model of the network device, the AI model of the terminal device, the sensing network of the terminal device, and a channel state between the terminal device and the network device are updated, the method further includes:
S506: The network device sends a second index to the terminal device, and correspondingly, the terminal device receives the second index, where the mapping relationship #A includes a second mapping relationship between the second index and second configuration information.

Optionally, if the network device determines that the mapping relationship #A in S501 does not include the second mapping relationship, the network device may directly send the second configuration information to the terminal device.

The following uses an example in which the mapping relationship #A in S501 includes the second mapping relationship to describe a process in which the network device determines the second index.

In a possible implementation, if the network device determines that the AI model of the network device is updated, the network device determines the second configuration information based on an updated AI model of the network device, to determine the second index.

For example, if an adjustment amplitude of the AI model of the network device is updated from being originally less than a fourth threshold to being greater than the fourth threshold, the network device determines the second configuration information from the mapping relationship #A, to determine the second index, where the second configuration information is applicable to the updated AI model of the network device.

In a possible implementation, if the terminal device sends second indication information to the network device, where the second indication information indicates that the AI model of the terminal device is updated, the network device determines the second configuration information from the mapping relationship #A based on the second indication information, to determine the second index, where the second configuration information is applicable to an updated AI model of the terminal device.

In a possible implementation, if the terminal device sends third indication information to the network device, where the third indication information indicates that the sensing network of the terminal device is updated, the network device determines the second configuration information from the mapping relationship #A based on the third indication information, to determine the second index, where the second configuration information is applicable to an updated sensing network of the terminal device.

In a possible implementation, if the network device determines that the channel state between the terminal device and the network device is updated, and an updated channel state does not match the first configuration information, the network device determines the second configuration information from the mapping relationship #A based on the updated channel state, to determine the second index, where the second configuration information is applicable to the updated channel state.

For beneficial effects of S506, refer to the foregoing descriptions. Details are not described herein again.

FIG. 6 shows a method 600. In the method 600, a manner in which a terminal device obtains first configuration information corresponding to first information is as follows: The terminal device obtains the first configuration information from predefined configuration information. Specifically, the method 600 includes the following steps.

S601: The terminal device obtains the first configuration information from the predefined configuration information.

For related descriptions of the first configuration information, refer to S201.

It should be understood that the terminal device and a network device may comply with a same communication protocol, and configuration information is predefined in the communication protocol.

In a manner, the predefined configuration information includes one or more of the following: a type of the first information, a quantization granularity of the first information, a feedback resource of the first information, a feedback periodicity of the first information, a measurement resource corresponding to the first information, a reference signal corresponding to the first information, and a mapping relationship between the reference signal corresponding to the first information and the measurement resource corresponding to the first information.

For example, the predefined configuration information may be shown in Table 3 in S501.

In a possible implementation, the terminal device obtains, from the predefined configuration information, configuration information corresponding to CSI.

In a possible implementation, the terminal device obtains, from the predefined configuration information, configuration information corresponding to related information of an AI model.

In a possible implementation, the terminal device obtains, from predefined configuration information, configuration information corresponding to related information of a sensing network.

In a possible implementation, the terminal device obtains, from the predefined configuration information, configuration information corresponding to related information of system performance.

It should be understood that the foregoing possible implementations are not separated, and may be combined with each other. For example, if the type of the first information includes the CSI and the related information of the sensing network, the terminal device obtains, from the predefined configuration information, the configuration information corresponding to the CSI and the configuration information corresponding to the related information of the sensing network.
S602: The terminal device sends the first information to the network device based on the first configuration information, and correspondingly, the network device receives the first information from the terminal device.

For this process, refer to S202.
S603: The network device assists an AI model of the network device based on the first information.

For this process, refer to S203.

According to the method in this application, the terminal device may obtain the first configuration information from the predefined configuration information. For different types of first information, corresponding first configuration information may also be different. Therefore, the terminal device may flexibly send a plurality of types of first information based on a plurality of types of first configuration information. Compared with a method in which a terminal device sends a plurality of types of first information based on a same type of configuration information, the method in this application can improve resource utilization and system spectrum utilization.

Optionally, if one or more of the AI model of the network device, an AI model of the terminal device, a sensing network of the terminal device, and a channel state between the terminal device and the network device are updated, the method further includes:
S604: The terminal device obtains second configuration information, where the second configuration information is used to update the first configuration information, and the first configuration information is different from the second configuration information.

Optionally, in a manner, the terminal device may independently determine the second configuration information. For a specific process, refer to S305. Details are not described herein again.

Optionally, in another manner, the terminal device may obtain the second configuration information from the network device. For a specific process, refer to S405. Details are not described herein again.

For beneficial effects of S604, refer to the foregoing descriptions. Details are not described herein again.

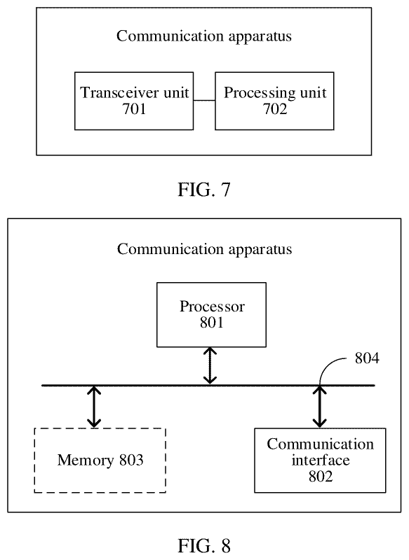

According to the foregoing method, FIG. 7 shows a communication apparatus according to an embodiment of this application. The communication apparatus includes a transceiver unit 701 and a processing unit 702.

The transceiver unit 701 may be configured to implement a corresponding information receiving and sending function. The transceiver unit 701 may also be referred to as a communication interface or a communication unit. The processing unit 702 may be configured to perform a processing operation.

For example, the apparatus further includes a storage unit. The storage unit may be configured to store instructions and/or data. The processing unit 702 may read the instructions and/or the data in the storage unit, so that the apparatus implements actions of the apparatus in the foregoing method embodiments.

In a first implementation, the apparatus may be the network device in the foregoing embodiments, or may be a component (for example, a chip) of the network device. The transceiver unit and the processing unit may be configured to implement related operations of the network device in the foregoing method embodiments. For example, the transceiver unit is configured to implement S402, and the processing unit is configured to implement S203, S304, S404, S505, or S603.

In a second implementation, the apparatus may be the terminal device in the foregoing embodiments, or may be a component (for example, a chip) of the terminal device. The transceiver unit and the processing unit may be configured to implement related operations of the terminal device in the foregoing method embodiments. For example, the transceiver unit is configured to implement S202, S302, S303, S403, S504, or S602, and the processing unit is configured to implement S301.

It should be understood that a specific process of performing the foregoing corresponding step by each unit is described in detail in the foregoing method embodiments. For brevity, details are not described herein again.

It should be further understood that the apparatus herein is presented in a form of a functional unit. The term “unit” herein may refer to an application-specific integrated circuit (ASIC), an electronic circuit, a processor (for example, a shared processor, a dedicated processor, or a group processor) configured to execute one or more software or firmware programs, a memory, a merged logic circuit, and/or another appropriate component that supports the described function. In an optional example, a person skilled in the art may understand that the apparatus may be specifically the first network element in the foregoing embodiments, and may be configured to perform the procedures and/or steps corresponding to the first network element in the foregoing method embodiments. Alternatively, the apparatus may be specifically the network management network element in the foregoing embodiments, and may be configured to perform the procedures and/or steps corresponding to the network management network element in the foregoing method embodiments. To avoid repetition, details are not described herein again.

The foregoing communication apparatus has a function of implementing corresponding steps performed by the apparatus in the foregoing method. The function may be implemented by hardware, or may be implemented by executing corresponding software by hardware. The hardware or software includes one or more modules corresponding to the foregoing function. For example, the transceiver unit may be replaced with a transceiver (for example, a sending unit in the transceiver unit may be replaced with a transmitter, and a receiving unit in the transceiver unit may be replaced with a receiver), and another unit such as a processing unit may be replaced with a processor, to separately perform receiving and sending operations and a related processing operation in the method embodiments.

In addition, the transceiver unit 701 may be a transceiver circuit (for example, the transceiver circuit may include a receiver circuit and a transmitter circuit), and the processing unit may be a processing circuit.

It should be noted that the apparatus in FIG. 7 may be the apparatus in the foregoing method embodiments, or may be a chip or a chip system, for example, a system-on-a-chip (SoC). The transceiver unit may be an input/output circuit or a communication interface. The processing unit is a processor, a microprocessor, or an integrated circuit integrated on the chip. This is not limited herein.

An embodiment of this application further provides a communication apparatus. As shown in FIG. 8, the communication apparatus includes a processor 801 and a communication interface 802. The processor 801 is configured to: execute a computer program or instructions stored in a memory 803, or read data stored in the memory 803, to perform the methods in the foregoing method embodiments. For example, there are one or more processors 801. The communication interface 802 is configured to: receive and/or send a signal. For example, the processor 801 is configured to control the communication interface 802 to receive and/or send a signal.

Optionally, as shown in FIG. 8, the communication apparatus may further include the memory 803, and the memory 803 is configured to store a computer program or instructions and/or data. The memory 803 may be integrated with the processor 801, or may be disposed separately. Certainly, the communication apparatus may alternatively not include the memory 803, and the memory 803 is disposed outside the communication apparatus. For example, there are one or more memories 803.

Optionally, the processor 801, the communication interface 802, and the memory 803 are connected to each other through a bus 804. The bus 804 may be a peripheral component interconnect (PCI) bus, an extended industry standard architecture (EISA) bus, or the like. The bus 804 may be classified into an address bus, a data bus, a control bus, and the like. For ease of representation, only one thick line is for representing the bus in FIG. 8, but this does not mean that there is only one bus or only one type of bus.

For example, the processor 801 is configured to execute the computer program or the instructions stored in the memory 803.

In a first implementation, the device may be the network device in the foregoing embodiments, or may be a component (for example, a chip) of the network device. The communication interface and the processor may be configured to implement related operations of the network device in the foregoing method embodiments. For example, the communication interface is configured to implement S402, and the processor is configured to implement S203, S304, S404, S505, or S603.

In a second implementation, the device may be the terminal device in the foregoing embodiments, or may be a component (for example, a chip) of the terminal device. The communication interface and the processor may be configured to implement related operations of the terminal device in the foregoing method embodiments. For example, the communication interface is configured to implement S202, S302, S303, S403, S504, or S602, and the processor is configured to implement S301.

It should be understood that a processor (for example, the processor 801) mentioned in embodiments of this application may be a central processing unit (CPU), a network processor (NP), or a combination of a CPU and an NP. The processor may further include a hardware chip. The hardware chip may be an application-specific integrated circuit (ASIC), a programmable logic device (PLD), or a combination thereof. The PLD may be a complex programmable logic device (CPLD), a field-programmable logic gate array (FPGA), a generic array logic (GAL), or any combination thereof.

It should be further understood that a memory (for example, the memory 803) mentioned in embodiments of this application may be a volatile memory or a non-volatile memory, or may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in another manner. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, in other words, may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When functions are implemented in a form of a software functional unit and sold or used as an independent product, the functions may be stored in a computer-readable storage medium. This application provides a computer-readable storage medium, including a computer program. When the computer program is run on a computer, the computer is enabled to perform the method according to any one of the possible implementations of the foregoing method embodiments.

The technical solutions of this application essentially, or the part contributing to the conventional technology, or some of the technical solutions may be implemented in a form of a software product. A computer program product is provided. The computer program product includes a computer program (which may also be referred to as code or instructions). When the computer program is run, a computer is enabled to perform the method according to any one of the possible implementations of the foregoing method embodiments. The computer software product is stored in a storage medium, and includes several instructions for instructing a computer device (which may be a personal computer, a server, a network device, or the like) to perform all or some of the steps of the method in embodiments of this application.

The foregoing storage medium includes any medium that can store program code, for example, a USB flash drive, a removable hard disk, a ROM, a RAM, a magnetic disk, or an optical disc.

Mutual reference may be made to content in embodiments of this application. Unless otherwise specified or a logical conflict occurs, terms and/or descriptions in different embodiments are consistent and may be referenced by each other. Technical features in different embodiments may be combined to form a new embodiment based on an internal logical relationship thereof.

It may be understood that, in embodiments of this application, the UE and/or the base station may perform some or all of the steps in embodiments of this application. These steps or operations are merely examples. In embodiments of this application, other operations or variations of various operations may be further performed. In addition, the steps may be performed in a sequence different from a sequence presented in embodiments of this application, and not all operations in embodiments of this application need to be performed.

1. A method, applied to a communication apparatus, the method comprising:
obtaining first configuration information, wherein the first configuration information indicates one or more of:
a type of first information,
a quantization granularity of the first information,
a feedback resource of the first information,
a feedback periodicity of the first information,
a measurement resource corresponding to the first information,
a reference signal corresponding to the first information, or
a mapping relationship between the reference signal corresponding to the first information and the measurement resource corresponding to the first information; and
sending the first information to a network device based on the first configuration information, wherein the first information is used to assist an artificial intelligence (AI) model of the network device.

2. The method according to claim 1, wherein:
the quantization granularity of the first information is related to a quality of service requirement of the first information,
the feedback periodicity of the first information is related to a change frequency of the first information,
the feedback resource of the first information is related to an adjustment amplitude of the AI model of the network device, or
the measurement resource corresponding to the first information is related to the type of the first information.

3. The method according to claim 1, wherein the obtaining the first configuration information comprises at least one of:
determining the quantization granularity of the first information based on a quality of service requirement of the first information; or
determining the feedback periodicity of the first information based on a change frequency of the first information.

4. The method according to claim 3, wherein the method further comprises:
sending at least one of the quantization granularity of the first information or the feedback periodicity of the first information to the network device.

5. The method according to claim 1, wherein the obtaining the first configuration information comprises:
obtaining the first configuration information from predefined configuration information; or
obtaining the first configuration information from the network device; or,
obtaining the first configuration information based on the mapping relationship and a first index, wherein the mapping relationship indicates a relationship between indexes and configuration information, and the mapping relationship comprises a first mapping relationship between the first index and the first configuration information.

6. The method according to claim 5, wherein:
the mapping relationship between the indexes and the configuration information is predefined; or
the method further comprises: obtaining the mapping relationship between the indexes and the configuration information from the network device.

7. The method according to claim 1, wherein the method further comprises:
obtaining second configuration information different from the first configuration information, wherein the first configuration information is updated based on the second configuration information.

8. A method, applied to a communication apparatus, the method comprising:
receiving first information, wherein the first information corresponds to first configuration information, and the first configuration information comprises one or more of:
a type of the first information,
a quantization granularity of the first information,
a feedback resource of the first information,
a feedback periodicity of the first information,
a measurement resource corresponding to the first information,
a reference signal corresponding to the first information, or
a mapping relationship between the reference signal corresponding to the first information and the measurement resource corresponding to the first information; and
assisting an artificial intelligence (AI) model of a network device based on the first information, the network device comprises the communication apparatus.

9. The method according to claim 8, wherein:
the quantization granularity of the first information is related to a quality of service requirement of the first information,
the feedback periodicity of the first information is related to a change frequency of the first information,
the feedback resource of the first information is related to an adjustment amplitude of the AI model of the network device, or
the measurement resource corresponding to the first information is related to the type of the first information.

10. The method according to claim 8, wherein the method further comprises:
sending the first configuration information; or
sending a first index and a mapping relationship between indexes and configuration information, wherein the mapping relationship comprises a first mapping relationship between the first index and the first configuration information.

11. The method according to claim 8, wherein the method further comprises:
sending, in response to one or more of: the AI model of the network device, an AI model of a terminal device, a sensing network of the terminal device, or a channel state between the terminal device and the network device being updated, second configuration information different from the first configuration information, wherein the first configuration information is updated based on the second configuration information.

12. A communication apparatus, comprising a processor coupled to a memory storing computer-executable instructions, which when executed by the processor, cause the communication apparatus to perform operations including:
obtaining first configuration information, wherein the first configuration information comprises one or more of:
a type of first information,
a quantization granularity of the first information,
a feedback resource of the first information,
a feedback periodicity of the first information,
a measurement resource corresponding to the first information,
a reference signal corresponding to the first information, or
a mapping relationship between the reference signal corresponding to the first information and the measurement resource corresponding to the first information; and
sending the first information to a network device based on the first configuration information, wherein the first information is used to assist an artificial intelligence (AI) model of the network device.

13. The communication apparatus according to claim 12,
wherein the quantization granularity of the first information is related to a quality of service requirement of the first information,
the feedback periodicity of the first information is related to a change frequency of the first information,
the feedback resource of the first information is related to an adjustment amplitude of the AI model of the network device, or
the measurement resource corresponding to the first information is related to the type of the first information.

14. The communication apparatus according to claim 12, the obtaining the first configuration information comprises at least one of:
determining the quantization granularity of the first information based on a quality of service requirement of the first information; or
determining the feedback periodicity of the first information based on a change frequency of the first information.

15. The communication apparatus according to claim 14, the operations further comprising:
sending at least one of the quantization granularity of the first information or the feedback periodicity of the first information to the network device.

16. The communication apparatus according to claim 12, wherein obtaining the first configuration information comprises:
obtaining the first configuration information from predefined configuration information; or
obtaining the first configuration information from the network device; or,
obtaining the first configuration information based on the mapping relationship and a first index, wherein the mapping relationship indicates a relationship between indexes and configuration information and the mapping relationship comprises a first mapping relationship between the first index and the first configuration information.

17. The communication apparatus according to claim 16, wherein:
the mapping relationship between the indexes and the configuration information is predefined; or
the operations further comprise: obtaining the mapping relationship between the indexes and the configuration information from the network device.

18. The communication apparatus according to claim 12, the operations further comprising:
obtain second configuration information different from the first configuration information, wherein the first configuration information is updated based on the second configuration information.
